(19) United States
(12) Patent Application Publication
(10) Pub. No.: US 2016/0289492 A1
(43) Pub. Date: Oct. 6, 2016

(54) EPOXY RESIN COMPOSITIONS

(71) Applicant: BLUE CUBE IP LLC, Midland, MI (US)

(72) Inventors: Yinzhong GUO, Midland, MI (US); Ray Drumright, Midland, MI (US); Christian Piechocki, Marienthal (FR); Peter Margl, Midland, MI (US); Tzu-Chi Kuo, Midland, MI (US)

(21) Appl. No.: 15/102,013

(22) PCT Filed: Dec. 3, 2014
(86) PCT No.: PCT/US2014/068311

§ 371 Date: Jun. 6, 2016

Related U.S. Application Data
(60) Provisional application No. 61/912,940, filed on Dec. 6, 2013.

(51) Int. Cl. C09D 163/00; C08L 63/00; C08K 5/17; C08G 59/06

(52) U.S. Cl. CPC C09D 163/00; C08G 59/063; C08L 63/00; C08K 5/17

(57) ABSTRACT

An epoxy resin composition of Formula (I), where X is an arylene structure derived from a compound selected from the group consisting of a monocyclic aromatic hydrocarbon, a polycyclic aromatic hydrocarbon, or a combination thereof, where an epoxy equivalent weight (EEW) of the epoxy resin composition is in a range from 150 to 500, and where m is in a mean average Cnumber in a range from 0.1 to 3.

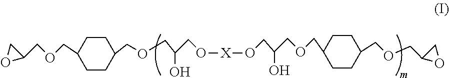

### TECHNICAL FIELD

The present disclosure relates to epoxy resin compositions.

### BACKGROUND

Epoxy resins are employed for various purposes. For example, epoxy resins, i.e., an epoxy coating formulation, can be applied to a surface and cured thereon to form a cured coating. The cured coating can provide functional properties and/or cosmetic properties for the various utilizations.

Epoxy coating formulations may include solvents to provide a reduction in viscosity of an epoxy resin composition included in the epoxy coating formulation. The reduction in viscosity, for example to below 3000 centipoises (cP) at 25° Celsius (C) provided by the solvents may, for instance, promote application of the epoxy coating formation. However, such solvents may be costly and/or have environmental concerns associated with their use among other disadvantages. For instance, volatile organic compounds (VOC)s contained in some solvents and/or resultant epoxy coating formulations including the same may be subject to environmental constraints on their use. Examples of VOCs include toluene, benzene, etc., among other compounds as generally understood having relatively low boiling points such that the VOC volatizes during curing of an epoxy including the VOC. Therefore, for some applications it is desirable to use as little solvent as possible, e.g., to reduce costs and/or avoid environmental concerns associated with solvent use.

In an effort to reduce or eliminate the use of solvents, diluents may be added to some epoxy resin compositions. Diluents (e.g., reactive diluents) refer to compositions that are provided in addition to an epoxy resin composition that provide a reduction in viscosity of the epoxy coating formulation. Examples of commercially available diluents include monofunctional glycidyl ethers such as C12-C14 alkyl glycidyl ether and cresol glycidyl ether, which are used in products such as D.E.R. 321, RoyOxy™ RAR 903, and/or FLEXIGARD 500S, among other products including monofunctional glycidyl ethers . While adding diluents may reduce the viscosity of a given composition, the use of additional diluents in compositions has some disadvantages. For example, addition of diluents to an epoxy resin composition may reduce the performance properties (for example, chemical resistance, impact resistance, water resistance, and corrosion resistance) of a resultant coating formed from such an epoxy resin composition due to the low functionality and/or reactivity of the added diluents.

In an effort to avoid the above described drawbacks associated with solvent and/or diluents some approaches have utilized low viscosity hardeners in epoxy resin compositions. While such hardeners may lower the viscosity of the overall epoxy resin composition their use has some disadvantages. For example, low viscosity hardeners may have a comparatively high reactivity and/or low miscibility compared to other hardeners (e.g., amine hardeners) which may result in epoxy resin compositions including the low viscosity hardeners having a comparatively short pot life, longer induction times, blooming/blushing, and/or being relatively difficult to work with, especially for coating utilizations.

What is needed, therefore, is a low viscosity, solvent-less epoxy resin composition containing no additional diluents that when formulated into a curable composition cures rapidly; and such that when cured, the resulting cured coating exhibits desired performance properties such as good resistance to corrosion. In addition, there is a need for easy to apply chemical resistant coatings with good flexibility and good impact resistance.

### SUMMARY

As provided herein, the present disclosure provides a low viscosity, solvent-less epoxy resin composition containing no additional diluents that when formulated into a curable composition cures rapidly and provides a cured coating that exhibits the desired performance properties such as good resistance to corrosion, ease of application, good chemical resistance and good flexibility and impact resistance. Specifically, the present disclosure provides an epoxy resin composition having the following general formula (I):

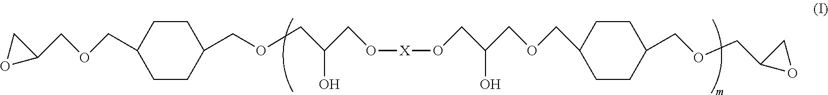

where X is an arylene structure derived from a group consisting of monocyclic aromatic hydrocarbons, polycyclic aromatic hydrocarbons, or a combination thereof, where an epoxy equivalent weight (EEW) of the epoxy resin composition is in a range from 150 to 500, and where m is in a mean average number in a range from 0.1 to 3. As a result, use of 100% solid (e.g., solvent-less and/or without additional diluents) epoxy resin compositions is practical due to a relatively low viscosity of the epoxy resin compositions and resultant curable compositions disclosed herein. That is, the present disclosure provides a curable composition including the solvent-less epoxy resin composition having no additional diluents, as disclosed herein, and a hardener, where the hardener reacts with the epoxy resin composition to form the curable composition. Additionally, the present disclosure provides a coated article including a substrate and a cured coating on the substrate, where the cured coating is formed by curing the curable composition, disclosed herein.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

In a broad scope, the present disclosure includes a low viscosity curable epoxy resin composition useful in coating applications and having desired and/or improved properties relating to properties such as chemical resistance, corrosion resistance, flexibility, and/or increased impact resistance, among other properties, without the use of solvents and/or additional diluents, as discussed herein.

The epoxy resin composition of the present disclosure has the structure depicted in Formula(I):

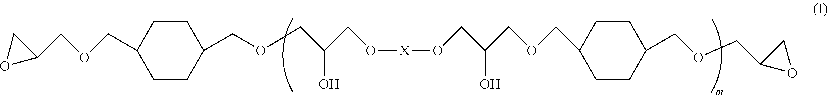

where X of the epoxy resin composition is an arylene structure derived from a compound selected from the group consisting of a monocyclic aromatic hydrocarbon, a polycyclic aromatic hydrocarbon, or a combination thereof.

The epoxy resin composition, disclosed herein, can include a reaction product of (a) at least one cycloaliphatic diglycidyl ether compound, and (b) at least one aromatic diol, where an epoxy equivalent weight (EEW) of the cycloaliphatic diglycidyl ether compound is in a range of from 128 to 150.

The at least one cycloaliphatic diglycidyl ether compound can be selected from the group consisting of 1,4-cyclohexanedimethanol diglycidyl ether (CHDM DGE), formed as described herein, having the following chemical structure, Structure (II):

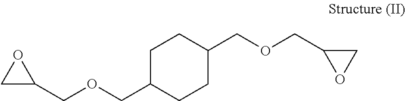 [SMILES: C1CC(COCC2CO2)CCC1COCC1CO1]

Other cycloaliphatic diglycidyl ether compounds (among other oligomers and monomers) are also possible.

CHDM DGE shown in Structure (II) above is one of the main components used to make the epoxy resin composition of the present disclosure. The CHDM DGE portion in the epoxy resin composition may consist of both cis- and trans-isomers. The epoxy resin composition in the present disclosure can also contain others species such as higher molecular weight oligomers and monoglycidyl ether components.

The at least one aromatic diol can be selected from the group derived from a polycyclic aromatic hydrocarbon such as bisphenol compounds for example Bisphenol-A, Bisphenol-F, Bisphenol-AF, Bisphenol-B, Bisphenol-BP, Bisphenol-C, Bisphenol-E, Bisphenol-G, Bisphenol-M, Bisphenol-S, Bisphenol-P, Bisphenol-PH, Bisphenol-TMC, Bisphenol-Z, among other aromatic diols derived from polycyclic aromatic hydrocarbon compounds, or a combination thereof, and/or can be selected from the group derived from a monocyclic aromatic hydrocarbon such as catechol, a substituted catechol, resorcinol, a substituted resorcinol, hydroquinone, a substituted hydroquinone, or a combination thereof.

The EEW of the epoxy resin composition of the present disclosure can range for example from a lower limit of 150 to an upper limit of 500, specifically an upper limit less than or equal to 350 in another embodiment, more specifically an upper limit less than or equal to 250 in still another embodiment, further a lower limit greater than or equal to 180 in a further embodiment, further still a lower limit greater than or equal to 200 in a further still embodiment.

A particular molecule of the epoxy resin composition of Formula I can have an integer value representative of a number of repeating units of the particular molecule. As used herein, m, is a mean average value of repeating units of m₁ . . . . mₙ of a number “n” of the epoxy resin composition(s) of the formula (I) of the present disclosure, where the mean average value, m, is calculated according to the formula m=(1/n) Σ₁ⁿ mᵢ. For instance, m can range for example from a lower limit of 0.1 to an upper limit of 3, specifically an upper limit less than or equal to 2.5 in another embodiment, more specifically an upper limit less than or equal to 2.0 in still another embodiment, further a lower limit greater than or equal to 0.5 in a further embodiment, further still a lower limit greater than or equal to 1.0 in a further still embodiment.

Advantageously epoxy resin composition of the present disclosure has several beneficial characteristics such as being solvent-less, not including additional diluent, having a low total chlorine content (e.g., less than 2 wt %). For instance, the “Solvent-free” or “free of solvent” or “solventless” with reference to a curable composition herein means essentially free of added volatile solvent material and/or non-volatile solvent material in the curable composition, i.e., no solvent is intentionally added to the curable composition of the present disclosure and the amount of solvent present in the curable composition is essentially zero. However, in some embodiments, a comparatively low amount of solvent can be included in the curable composition. For example, the amount of solvent in the curable composition can range from a lower limit of 0.1 wt % to an upper limit of 15 wt%, specifically an upper limit less than or equal to 10% in another embodiment, based on a total weight of the curable composition.

Embodiments of the present invention can include reacting the cycloaliphatic diglycidyl ether compound and the at least one aromatic diol in a molar ratio of the cycloaliphatic diglycidyl ether compound to the at least one aromatic diol in a range from 1.5 to 1.0 to 10.0 to 1.0. Further, all individual values and subranges from and including 1.5 to 1.0 to 10.0 to 1.0 are included; for example, the molar ratio of the cycloaliphatic diglycidyl ether compound to the at least one aromatic diol can be from a lower limit of 1.5 to 1.0, 2.0 to 1.0, or 3.0 to 1.0, or 4.0 to 1.0, or 5.0 to 1.0 to an upper limit of 10.0 to 1.0, 9.0 to 1.0, or 8.0 to 1.0, to 7.0 to 1.0, or 6.0 to 1. Specific examples include a molar ratio of the cycloaliphatic diglycidyl ether compound to the at least one aromatic diol in a range from 1.5 to 1.0 to 10.0 to 1.0, or from 3.0 to 1.0 to 9.0 to 1.0, or from 5.0 to 1.0 to 7.0 to 1.0. Such a range (e.g., from 1.5 to 1.0 to 10.0 to 1.0) can provide an excess of the cycloaliphatic diglycidyl ether compound with respect to the at least one aromatic diol (e.g., to provide excess epoxide groups for reaction). Reacting the at least one aromatic diol with an excess amount of the cycloaliphatic diglycidyl ether compound, and thus providing an excess number of epoxide groups, can help promote formation of an epoxide-terminated polymer.

“Not including additional diluent” or “without additional diluent” or “without diluent” with reference to the curable composition herein means essentially free of added diluent material to the epoxy resins compositions disclosed herein, i.e., no additional diluent is intentionally added to the epoxy resin compositions and/or curable composition of the present disclosure and the amount of diluent present in the curable composition is essentially zero. However, some amount of unreacted CHDM diglycidyl ether may be present in the epoxy resin composition as a consequence of preparing the epoxy resin composition of the present disclosure having the Formula (I), as disclosed herein.

Additionally, some amount of CHDM monoglycidyl ether content may be present in the epoxy resin composition as a consequence of preparing the composition. CHDM monoglycidyl ether content is measured as described in the Examples section herein.

The total chlorine (Cl) content of the CHDM Epoxy Resin used in preparing the epoxy resin composition of the present disclosure generally can be less than 2 wt % in one embodiment, from 0.01 wt % to 1 wt % in another embodiment, from 0.01 wt % to 0.5 wt % in still another embodiment, from 0.01 wt % to 0.25 wt % in yet another embodiment, and from 0.01 wt % to 0.1 wt % in even still another embodiment, based on the weight of the total components in the epoxy resin. A lower concentration of chlorine in the epoxy resin is more advantageous in forming the curable composition of the present disclosure. An epoxy resin containing a Cl concentration of greater than 2 wt %, when used in preparing a curable composition, can result in a coating film showing signs of blistering and whitening when such curable composition having high levels of Cl is used in producing a cured coating film. Cl is measured as described in the Examples section herein.

The EEW of the CHDM Epoxy Resin used in preparing the epoxy resin composition of the present disclosure can range for example from a lower limit of 128 to an upper limit of 150 in one embodiment, specifically an upper limit less than or equal to 143 in another embodiment, more specifically an upper limit less than or equal to 140 in still another embodiment, further a lower limit greater than or equal to 132 in a further embodiment, further still a lower limit greater than or equal to 137 in a further still embodiment. EEW is measured as described in the Examples section herein.

Embodiments of the present disclosure provide a curable composition including the epoxy resin composition, as disclosed herein, and a hardener, where the hardener reacts with the epoxy resin composition to form a cured coating. The hardener can be a phenolic, a thiol, an anhydride, an amine, or a combination thereof. Examples of suitable anhydrides are selected from the group consisting of hexahydrophthalic anhydride, methyltetrahydrophthalic anhydride, methylhexahydrophthalic anhydride, methylnadic anhydride, methylbutenyltetrahydrophthalic anhydride or a combination thereof.

In some embodiments, an amine hardener can include at least one of Polypox® (IH 7001, IH 7002, IH 7003, IH 7004, H 013, H 014, H 015, H 016, H 030, H 038, H 043, H 043 S, H 043 L, H 051, H 060, H 100, H 129, H 147, H 160, H 205, H 206, H 229, H 244, H 262, H 269, H 276/90, H 300, H 300 S, H 300 SL, H 310, H 333, H 354, H 354 L, H 415, H 445, H 445 L, H 480, H 483, H 488, H 488 L, H 489, H 490, H 497, H 501, H 503, H 610, and/or H 611). Further examples of suitable amines are selected from the group consisting of ethylenediamine; diethylenetriamine; triethylenetetramine; trimethyl hexane diamine; hexamethylenediamine; N-(2-aminoethyl)-1,3-propanediamine; N,N′-1, 2-ethanediylbis-1,3-propanediamine; dipropylenetriamine; m-xylylenediamine; p-xylylenediamine; 1,3-bisaminocyclohexylamine; isophorone diamine; 4, 4′-methylenebiscyclohexaneamine; m-phenylenediamine; diaminodiphenylmethane; diaminodiphenylsulfone; N-aminoethylpiperazine; 3,9-bis(3-aminopropyl) 2,4,8, 10-tetraoxaspiro(5,5)undecane; 4,7-dioxadecane-1,10-diamine; 1-propanamine; (2, 1-ethanediyloxy)-bis-(diaminopropylated diethylene glycol) (ANCAMINE® 1922A); poly(oxy(methyl-1,2-ethanediyl)), alpha-(2-aminomethylethyl)omega-(2-aminomethylethoxy) (JEFFAMINE® D-230, D-400); triethyleneglycoldiamine; and oligomers (JEFFAMINE® XTJ-504, JEFFAMINE® XTJ-512); poly(oxy(methyl-1, 2-ethanediyl)), alpha,alpha′-(oxydi-2,1-etha nediyl)bis(omega-(aminomethylethoxy)) (JEFFAMINE® XTJ-511); bis(3-aminopropyl)polytetrahydrofuran 350; bis (3-aminopropyl)polytetrahydrofuran 750; poly(oxy(methyl-1,2-ethanediyl)); α-hydro-ω̅-(2-aminomethylethoxy) ether with 2-ethyl-2-(hydroxymethyl)-1,3-propanediol (JEFFAMINE® T-403); diaminopropyl dipropylene glycol; amine adducts; Mannich bases; phenalkamines; amides; polyamides; or a combination thereof.

Regardless of a presence of the unreacted CHDM diglycidyl ether and/or CHDM monoglycidyl ether, as described above, in some embodiments, the curable composition of the present disclosure does include another epoxy resin other than the epoxy resin composition (I) disclosed herein.

The present disclosure provides a coated article including a substrate and a cured coating on the substrate, where the cured coating is formed by curing the curable composition, disclosed herein. For example, in some embodiments, the substrate can be selected from a group consisting of concrete, metal, or a combination thereof.

### EXAMPLES

Objects and advantages of this disclosure are further illustrated by the following examples, but the particular materials and amounts thereof recited in these examples, as well as other conditions and details, should not be construed to unduly limit this disclosure. Unless otherwise indicated, all parts and percentages are by weight and all molecular weights are weight average molecular weight.

### Materials

Al catalyst, Ethyltriphenylphosphonium acid acetate (ETPPAAc) solution, 70 wt % in methanol, obtained from Dow Chemical, a phosphonium salt catalyst.

1,4-cyclohexanedimethanol (CHDM, 99%, mixture of cis and trans; available from Eastman Chemical Company).

2-methylimidazole (available from Sigma-Aldrich, (99% purity)), a catalyst.

Anhydrous sodium sulfate (99.8%, certified ACS available from Fisher Scientific as product S421-3).

Benzyltriethylammonium chloride (available from StarChem, LLC).

Bisphenol A (2,2-bis(4-hydroxyphenyl)propane)(available from The DOW Chemical Company (98-99 wt % purity)), a bisphenol compound.

Bisphenol F (Available from Sigma-Aldrich)(95 wt % purity), a bisphenol compound.

CHDM epoxy resin was prepared by azeotropic epoxidation of CHDM with epichlorohydrin. A five liter, five neck, round bottom, flask was equipped with an addition funnel, a temperature controller, a heating mantle, a stirrer assembly, a source of nitrogen, and a source of vacuum. A high efficiency condenser (maintained at 0° C.) was connected to a water separator that was also attached to the flask.

For example, the flask was charged with (432.63 g, 3.0 moles, 6.0 hydroxy equivalents) of 1,4-cyclohexanedimethanol; (1110.24 g, 12.0 moles) epichlorohydrin; and, (54.53 g, 32.72 g active, 0.1436 mole) of a 60% aqueous benzyltriethylammonium chloride. The addition funnel was loaded with 470 mL of 50 wt % aqueous sodium hydroxide (9.0 moles). The reaction mixture was heated until a steady distillation of epichlorohydrin-water azeotrope was obtained and then dropwise addition of aqueous sodium hydroxide was commenced.

Upon completion of the aqueous sodium hydroxide addition, unreacted epichlorohydrin was distilled from the reaction mixture. Toluene (1.5 L) and water (1.8L) were added to the flask, mixed, and the layers separated. The organic phase was washed twice with deionized water (2×800 mL) and filtered through a bed of sodium sulfate and concentrated by rotary evaporation. A total of 778 g of CHDM Epoxy Resin was recovered as a light yellow colored, transparent, liquid with a measured EEW of 140 and total Cl of 0.2 wt. %.

Cashew Nut Shell Liquid (available from Beijing Huada Saigao Company with a hydroxyl equivalent weight of 200 comprising a mixture of cardol and cardanol at approximately equal weight ratio)

D.E.R.™ 671X75 (available from The DOW Chemical Company, epoxy resin of the “1-type” in 75% xylene solution).

D.E.R.™ 321 (available from The DOW Chemical Company) an epoxy resin formed from a reaction product of epichlorohydrin and bisphenol-A modified with an aromatic mono-functional reactive diluent, ortho-cresyl glycidyl ether.

D.E.R.™ 3680X90 (available from The DOW Chemical Company), an epoxy resin formed from a chemically modified reaction product of epichlorohydrin and bisphenol-A in a 90% xylene solution

Epichlorohydrin (>99.9%, available from The Dow Chemical Company), an epoxide.

Erisys™ GE22, a low purity cyclohexanedimethanol diglycidyl ether available from CVC Thermosets having an EEW of 159 as determined by titration and total Cl of 5.5 wt. %.

Polypox® H 015 and Polypox® H 488 (both available from UPPC GmbH), an amine hardener.

Methyl p-toluenesulfonate (available from Sigma-Aldrich (99% purity)), a catalyst.

Resorcinol (available from Sigma-Aldrich (99% purity)), an aromatic diol.

### Testing Methods

### Adhesion

Adhesion measurement of the cured coatings on metal substrates was conducted using the Cross Hatch Adhesion Test according to ASTM D3359-09, Test Method A. For instance, a coated sample was scribed with a razor (two 40 mm cuts, 30-45° angle), cutting through the coating to form an X. Double coated paper tape (3M No. 410) was then applied at the intersection of the cuts with the tape running in the same direction as the smaller angle, pressed down, and then rapidly stripped away. The coating was then visually inspected to determine how much coating was removed from the substrate. The scale follows: 5A-No peeling or removal, 4A-Trace peeling or removal along incisions or at their intersection, 3A-Jagged removal along incision up to 1.6 mm on either side, 2A-Jagged removal along most of incisions up to 3.2 mm on either side, 1A-Removal from most of the area of the X under the tape, 0A-Removal beyond the area of the X.

### Compositional Analysis

The composition of CHDM epoxy resins (i.e. CHDM monoglycidyl ether, CHDM diglycidyl ether, CHDM epoxy resin oligomers) were analyzed using a Hewlett Packard 5890 Series II Gas Chromatograph outfitted with a 60 m×0.248 mm×0.25 μm film thickness J&W GC column using a DB-1 stationary phase. The flame ionization detector was operated at 300° C. The injector temperature was maintained at 300° C. Helium carrier gas flow through the column was maintained at 1.1 mL per min. For the analysis, an initial 50° C. oven temperature with heating at 12° C. per min to a final temperature of 300° C. was used.

### Chemical Resistance Test

(3% Acetic Acid, 10% NaOH, 3% NaCl, Toluene, EtOH)

A couple drops of specified chemicals (including DI water, 3 wt % acetic acid in water, 10 wt % sodium hydroxide solution, 3 wt % sodium chloride in water, toluene, or ethanol) were deposited onto a coated panel. For those specified chemicals with low surface tension or quick evaporation, filter papers (25 mm diameter) were placed on the coatings prior to contacting the coated panel with the specified chemical. Plastic caps were used to cover the resulting droplets of chemicals on the surface of the coated panel or the saturated filter papers. After 24 hours, the chemicals were washed away with water and the panels were dried with paper towels. Coatings were immediately visually inspected for any signs of chemical attack or staining and such inspection was ranked on a 1-5 rating scale as follows: 5-No visible affect, 4-Slight blush, 3-Major blush, Slight blister, change in touch, 2-Major blisters, 1- Coating failure.

### Bound Cl, hydolyzable Cl and Ionic Chloride Analyses

The ionic and hydrolysable Cl were determined by titration while total Cl was determined by X-ray fluorescence and neutron activation.

### Conical Mandrel Bend Flexibility Test (Bend Flexibility)

Mandrel bend tests of coatings were carried out according to the procedure described in ASTM D522 (test method B). A BYK Gardner Conical Mandrel Bending Tester was used to measure the elongation and adhesion of a coated film after a bending stress. The use of the BYK Tester enabled testing of various bending radii (3.2 mm to 38 1 mm) simultaneously. According to this Test, a test panel was bent 180 degrees around the conical mandrel with the coated side up. The panel was then inspected for cracking and/or delamination of the coating from the substrate. Results were measured in terms of the length of cracking or delamination in millimeters from the narrowest (3.2 mm) end of the bend.

### Differential Scanning Calorimetry (DSC)

A DSC 2910 Modulated DSC (TA Instruments) was employed, using a heating rate of 7° C. per minute (min) from 25° C. to 250° C. under a stream of dry nitrogen flowing at 45 cubic centimeters per min. A standard sample weight of between 5 milligrams (mg)s to 10 mgs is used.

### Epoxy Equivalent Weight (EEW)

EEW calculated by titration using a Metrohm 905 Titrando titrator in accordance with ASTM D-1652. Briefly, a test sample is dissolved in a 2:1 mixture of methylene chloride and glacial acetic acid. Tetraethylammonium bromide is added and then the sample is titrated with perchloric acid with endpoint determined electrochemically.

### Epoxy/OH Ratio

The epoxy/OH ratio is a molar ratio of epoxide groups to hydroxyl groups and is calculated from knowledge of the equivalent weights and amounts of reactants.

### % Epoxy

% Epoxy was calculated in accordance with ASTM D-1652.

### Glass Transaction Temperature (TG)

TG was calculated using a TA Instruments Q 100 to perform DSC. Samples were weighed into hermetically sealed aluminum DSC pans. Samples were scanned at 10° C./min to 100° C. from 0° C. then scanned to 100° C., then cooled down to 80° C. and were scanned second time at 10° C./min to 180° C. to determine the glass transition temperature (Tg) measurement based on the second scan.

### Impact Resistance (Direct Impact and Indirect Impact)

Impact resistance for direct impact and indirect impact was calculated using that pendulum hardness measured using a Pendulum Hardness Tester from BYK Gardner equipped with a Konig pendulum in accordance with ISO 1522. Hardness was measured in seconds. For instance, by measuring the damping time in seconds of an oscillating pendulum as its amplitude decreases from 6° to 3° . The pendulum rests with 2 stainless steel balls, 5mm in diameter, on the coating surface. When the pendulum is set into motion, the balls roll on the surface and put pressure on the coating. Depending on the elasticity of the coating, the damping will be stronger or weaker. If there are no elastic forces, the pendulum will damp stronger. High elasticity will cause weak damping. In other words, the amplitude of the pendulum oscillations decreases more rapidly with softer coatings resulting in shorter damping times.

### Molecular Weight (Mw)

Mw was calculated using a gel permeation chromatography (GPC) using a Max Serial Mode 2.3 with Pl-Gel Mixed-D columns in accordance with ASTM D-1652. For example, A PL-gel Mixed D pair of columns maintained at 40° C. were used in series along with a differential refractometer detector (Waters 410). Tetrahydrofuran was used as an eluent at a flow rate of 1 mL per min. The injection volume was 100 microliters. A sample was diluted in tetrahydrofuran to a concentration of 0.45-0.50%. Calibration was performed using Polymer Laboratories Polyethylene Glycol Calibrants, PEG 10, Lot 16. RSD for Mₙ, M_{w}, M_{w}/Mₙ, Mₚ and M_{z} was less than 3% and for M_{z}+1 RSD was less than 6%, with the exception of Examples 9-11 where RSD for Mₙ, M_{w}, M_{w}/Mₙ, Mₚ and M_{z} was less than 4% and for M_{z}+1 RSD was less than 8%. The chromatogram was visually examined and different peak windows were selected for individual integration of the respective peaks. The molecular weight at the apex of the peak and area % are less than 1% for peak windows greater than 10% of the total area and less than 10% for peak windows less than 10% of the total area. The area percent and peak molecular weights thus obtained were averaged to give the indicated results in the following Examples and Comparative Experiments.

### Number Average Molecular Weight (Mn)

Mn is total weight of all molecules of epoxy resin composition in an Example, divided by a total number of epoxy resin molecules, m, in a sample.

### Polydispersity Index (PDI)

PDI was calculated as Mw/Mn.

### Solvent Resistance

Solvent resistance testing was performed using the (methyl ethyl ketone) MEK double rub test in accordance with ASTM D5402. For instance, MEK Double Rub Test was performed using the semi-automatic MEK Double Rub Tester made by DJH DESIGNS INC. The testing continued until the coating was rubbed through to the substrate with the MEK or a maximum of 200 double rubs were completed without breakthrough.

Viscosity

Viscosity was calculated in accordance with Brookfield viscosity method using a Brookfield HADVIII+ Viscometer at 25° C. in accordance with ASTM D-445. For example, a 9 gram (g) sample was loaded into an adapter, put a #31 spindle, spun in a range 25-35% torque depending upon the sample to obtain a stabilized spin rate of between 31 and 34 rotations per min. Viscosity data was collected following 2 min of stabilization. The viscosity measurements are reported in units of centipoise (cP).

### Example 1

### Epoxy Resin Composition

Prepare an epoxy resin composition, Example 1, as follows. Add 206.13 grams (g) of CHDM Epoxy Resin to a 500 milliliter (ml) three-neck flask reactor at 25° C. Dry under nitrogen, the CHDM Epoxy Resin at 120° Celsius (° C.) for 2 hour (hr)s. Allow the CHDM Epoxy Resin to cool to 100° C. After cooling, add 20.00 g of Bisphenol-A to the flask reactor with agitation and admix the contents of the flask reactor until the Bisphenol-A dissolves. Heat the mixture to 120° C. Add 450 parts per million (ppm) of Al catalyst via a syringe. Heat the mixture to 150° C. until completion of the reaction as determined by obtaining a designed EEW for the epoxy resin composition as reported in Table 1. The measured properties of the epoxy resin composition, Example 1, are reported in Table 2.

### Examples 2-3 Epoxy Resin Compositions

Prepare epoxy resin compositions, Examples 2-3, prepared as Example 1 by utilizing different amounts of Bisphenol-A and the CHDM Epoxy Resin, which are reported in Table 1. Additionally, a designed EEW and a ratio of epoxy groups to hydroxyl groups for each of Examples 2-3 is reported in Table 1. The measured properties of the epoxy resin compositions, Examples 2-3, are reported in Table 2.

### Example 4 Epoxy Resin Composition

Prepare an epoxy resin composition, Example 4, as follows. Add 293.66 g of CHDM Epoxy Resin to a 500 ml three-neck flask reactor at 25° C. Dry under nitrogen, the CHDM Epoxy Resin at 120° C. for 2 hrs. Allow the CHDM Epoxy Resin to cool to 100° C. After cooling, add 25.00 g of Bisphenol-F to the flask reactor with agitation and admix the contents of the flask reactor until the Bisphenol-F dissolves. Heat the mixture to 120° C. and add 450 ppm of Al catalyst based via syringe. Heat the mixture to 150° C. until completion of the reaction as determined by obtaining a designed EEW for the epoxy resin composition as reported in Table 1. The measured properties of the epoxy resin composition, Example 4, are reported in Table 2.

### Examples 5-6 Epoxy Resin Compositions

Prepare epoxy resin compositions, Examples 5-6, prepared as Example 4 by utilizing different amounts of Bisphenol-F and the CHDM Epoxy Resin, which are reported in Table 1. Additionally, a designed EEW and a ratio of epoxy groups to hydroxyl groups for each of Examples 5-6 is reported in Table 1. The measured properties of the epoxy resin compositions, Examples 5-6, are reported in Table 2.

### Example 7 Epoxy resin composition

Prepare an epoxy resin composition, Example 7, as follows. Add 320.41 g of CHDM Epoxy Resin to a 500 ml three-neck flask reactor at 25° C. Dry under nitrogen, the CHDM Epoxy Resin at 120° C. for 2 hrs. Allow the CHDM Epoxy Resin to cool to 100° C. After cooling, add 15.00 g of resorcinol to the flask reactor with agitation and admix the contents of the flask reactor until the resorcinol dissolves. Heat the mixture to 120° C. and add 450 ppm of Al catalyst via syringe. Heat the mixture to 150° C. until completion of the reaction as determined by obtaining a designed EEW for the epoxy resin composition as reported in Table 1. The measured properties of the epoxy resin composition, Example 7, are reported in Table 2.

### Examples 8-10 Epoxy Resin Compositions

Prepare epoxy resin compositions, Examples 8-10, prepared as Example 7 by utilizing different amounts of resorcinol, and the CHDM Epoxy Resin, which are reported in Table 1. Additionally, a designed EEW and a ratio of epoxy groups to hydroxyl groups for each of Examples 8-10 is reported in Table 1. The measured properties of the epoxy resin compositions, Examples 8-10, are reported in Table 2.

### Example 11 Epoxy Resin Composition

Prepare an epoxy resin composition, Example 11, as follows. Add 431.75 g of CHDM Epoxy Resin to a 1000 ml three-neck flask reactor at 25° C. Dry under nitrogen, the CHDM Epoxy Resin at 120° C. for 2 hrs. Allow the CHDM Epoxy Resin to cool to 100° C. After cooling, add 100.00 g of Cashew Nut Shell Liquid (CNSL) to the flask reactor with agitation and admix the contents of the flask reactor until the CNSL dissolves. Heat the mixture to 120° C. and add 450 ppm of Al catalyst via syringe. Heat the mixture to 150° C. until completion of the reaction as determined by obtaining a designed EEW for the epoxy resin composition as reported in Table 1. The measured properties of the epoxy resin composition, Example 11, are reported in Table 2

TABLE 1

| | | CHDM | | | |
|---|---|---|---|---|---|
| | | Epoxy | | | Epoxy/ |
| Epoxy resin | Aromatic | Resin | A1 | Designed | OH |
| compositions | diol (g) | (g) | Catalyst | EEW | ratio |
| Example 1 | 20.00 | 206.13 | 0.150 | 184.3 | 8 |
| Example 2 | 30.00 | 231.90 | 0.168 | 199.2 | 6 |
| Example 3 | 30.00 | 193.25 | 0.140 | 212.3 | 5 |
| Example 4 | 25.00 | 293.66 | 0.205 | 182.3 | 8 |
| Example 5 | 30.00 | 264.30 | 0.189 | 196.4 | 6 |
| Example 6 | 32.00 | 234.93 | 0.172 | 208.8 | 5 |
| Example 7 | 15.00 | 320.41 | 0.216 | 175.9 | 8 |
| Example 8 | 20.00 | 320.41 | 0.219 | 187.4 | 6 |
| Example 9 | 20.00 | 267.01 | 0.185 | 197.5 | 5 |
| Example 10 | 50.00 | 473.00 | 0.336 | 220.0 | 3.6 |
| Example 11 | 100.00 | 432.00 | 0.342 | 213.0 | 6 |

TABLE 2

| Epoxy resin | Viscosity | Tg | | % | | | |
|---|---|---|---|---|---|---|---|
| compostions | (cP at 25° C.) | (° C.) | EEW | Epoxy | Mn | Mw | PDI |
| Example 1 | 748 | −70.9 | 182 | 23.7 | 371 | 976 | 2.63 |
| Example 2 | 1720 | −59.0 | 199 | 21.6 | 414 | 1146 | 2.77 |
| Example 3 | 3149 | −55.6\grave{ } | 211 | 20.4 | 453 | 1254 | 2.77 |
| Example 4 | 663 | −70.1 | 182 | 23.6 | 438 | 1168 | 2.67 |
| Example 5 | 1367 | −67.6 | 197 | 21.8 | 487 | 1394 | 2.86 |
| Example 6 | 2210 | −56.2 | 208 | 20.7 | 533 | 1541 | 2.89 |
| Example 7 | 550 | −70.7 | 176 | 24.5 | 443 | 1171 | 2.64 |
| Example 8 | 1005 | −67.9 | 188 | 22.9 | 490 | 1534 | 3.13 |
| Example 9 | 1697 | −58.5 | 197 | 21.8 | 527 | 1603 | 3.04 |
| Example 10 | 4006 | 51.4 | 226 | 28.1 | 482 | 1206 | 2.50 |
| Example 11 | 303 | 67.2 | 211 | 35.0 | 403 | 906 | 2.25 |

### Comparative Example A

Prepare an epoxy resin composition having a comparatively higher viscosity, Comparative Example A, as follows. Charge 300 parts by weight of Erisys™ GE 22 (comparative cycloaliphatic cyclohexanedimethanol diglycidyl ether), 58.5 parts by weight of Bisphenol-A, and 0.02 parts by weight of 2-methylimidazole to 1000 ml three-neck flask reactor at 25° C. Agitate the mixture and heat the mixture to 150-155° C. under nitrogen. The reaction was exothermic and reached a temperature of 194° C. At this point, add 58.5 parts of Bisphenol-A to the reactor. Maintain the mixture at temperature in a range between 150° C. and 155° C. for 4 hrs. Measure properties of the epoxy resin composition, as disclosed herein. A viscosity, an EEW and various other measured properties for Comparative Example A are reported in Table 3.

### Comparative Examples B

Prepare an epoxy resin composition having a comparatively higher viscosity, Comparative Example B, prepared as Example 1, dry 300 parts of Erisys™ GE 22 with bubbling nitrogen in a 1000 ml three-neck flask reactor at 120° C. for 2hrs. Charge 117 parts of Bisphenol-A was into the flask reactor. Agitate the mixture until the bis-phenol-A dissolved completely. Add 450 ppm of Al catalyst into flask reactor at 120° C. and heat the flask reactor to 150° C. The reaction was exothermic and reached to 170° C. Maintain temperature at 155° C. for 1 hr. Add 1670 ppm methyl p-toluenesulfonate to the flask reactor. Measure properties of the epoxy resin composition. A viscosity, an EEW, and various other measured properties for Comparative Example B are reported in Table 3.

### Comparative Examples C,D, E

Mix each commercially available epoxy resin compositions including at least one solvent or diluent for 30 s in a mixer at 3500 rpm. Measure respective properties of commercially available epoxy resin compositions including at least one solvent or diluent. The measured properties reported in Table 3. The properties of Comparative Examples, C, D, and E, as reported in Table 3, correspond to properties measured for commercially available epoxy resin composition each including at least one solvent or diluent, D.E.R.™ 671X75, D.E.R.™ 321, and D.E.R.™ 3680X90, respectively.

TABLE 3

| Epoxy resin | Viscosity | Tg | | % | | | |
|---|---|---|---|---|---|---|---|
| compositions | (cP at 25° C.) | (° C.) | EEW | Epoxy | Mn | Mw | PDI |
| Comparative | 3,423,880 | −9.3 | 565.7 | 7.61 | 1233 | 2957 | 2.40 |
| Example A | | | | | | | |
| Comparative | 1,306,488 | −14.1 | 498.9 | 8.62 | 1233 | 2946 | 2.39 |
| Example B | | | | | | | |
| Comparative | 24,464 | 37.7 | 639.4 | 6.73 | 1055 | 2888 | 2.74 |
| Example C | | | | | | | |
| Comparative | 876 | — | 182.2 | 23.61 | 251 | 458 | 1.82 |
| Example D | | | | | | | |
| Comparative | 3701 | — | 261.6 | 16.43 | 440 | 1184 | 2.69 |
| Example E | | | | | | | |

The data in Table 2 shows that each of the epoxy resin compositions in Examples 1-11 have a desirable viscosity achieved without solvents or diluents, as evidenced by the representative components reported in Table 1, absent solvents or diluents. Such epoxy resin compositions have improved properties at similar viscosities and/or similar properties at reduced viscosities, as disclosed herein, which corresponds to improved industrial application, ease in manufacture, and/or improved performance of the epoxy resin composition and resultant coating incorporating the same, as disclosed herein, relative to each of the epoxy resin compositions formed from Comparative Examples A through E.

For instance, epoxy resin compositions, Examples 1-11, have an EEW in a range of from 176 to 226 and viscosities in a range of from 550 cP to 4006 cP at 25° C. achieved without solvents or diluents. In contrast, the epoxy resin compositions of Comparative Examples A and B have substantially higher viscosities of 3,423,880 and 1,306,488, respectively, than the viscosities of the epoxy resin compositions of each of Examples 1-11. Additionally, Comparative Examples C-E each include at least one solvent and/or diluent and/or have decreased performance (e.g., lower Mw) with respect to Examples 1-11 which do not include diluents or solvents.

### Examples 12-29 Curable Compositions Including a Hardner at a 1:1 Epoxy to Hardner Equivalent Ratio and Cured Coatings Formed Therefrom

Prepare curable compositions including a hardener, Examples 12-20, as follows. Add a hardner to the epoxy resin compositions of Examples 1-9. For instance, a curable composition, Example 12, corresponds to the addition of a hardener to the epoxy resin composition of Example 1. Similarly, prepare curable compositions, Examples 21-29, by addition of a hardener to the epoxy resin compositions of Examples 1-9. Two different hardeners, (amine, Polypox® H 015 or Polypox® H 488) were utilized in various amounts in Examples 12-20 and 21-29, respectively, as reported in Table 4.

Form cured coatings as follows. Apply a curable composition, such as those in Examples 12-29, to a substrate, for example, metal panels, according to ASTM D4147-99(2007). For instance, secure the substrate on a firm horizontal surface either by taping the top or using a magnetic chuck. Pour an ample amount of the coating across the top end of the substrate and place a 6 mil drawdown bar behind the coating. Draw the bar with uniform pressure and speed along the length of the substrate toward the operator to apply a uniform film. The wet and dry film coating thickness obtained is dependent on the combination of the bar used, the volume solids of the coating, and the speed of the drawdown motion. All thickness ranged from 2 mil to 4 mil, as shown in Table 8. After coating, cure the substrate(s) at 25° C. and ambient humidity for 7 days. Heat the substrate(s) to 60° C. for 12 hrs to ensure full cure had been obtained.

Properties (e.g., viscosity) of the curable compositions, 10-27, were tested along with the resultant properties of cured coatings to yield the results reported in Table 8.

TABLE 4

| | Epoxy resin | | Hardener |
|---|---|---|---|
| Curable | composition | | added |
| composition | added (g) | Hardener | (g) |
| Example 12 | 49.99 | Polypox ® H 015 | 20.62 |
| Example 13 | 49.99 | Polypox ® H 015 | 18.88 |
| Example 14 | 50.05 | Polypox ® H 015 | 17.77 |
| Example 15 | 50.01 | Polypox ® H 015 | 20.60 |
| Example 16 | 49.99 | Polypox ® H 015 | 19.01 |
| Example 17 | 50.00 | Polypox ® H 015 | 18.02 |
| Example 18 | 50.02 | Polypox ® H 015 | 21.32 |
| Example 19 | 49.99 | Polypox ® H 015 | 19.95 |
| Example 20 | 50.00 | Polypox ® H 015 | 19.04 |
| Example 21 | 50.00 | Polypox ® H 488 | 25.55 |
| Example 22 | 49.99 | Polypox ® H 488 | 23.35 |
| Example 23 | 49.99 | Polypox ® H 488 | 22.05 |
| Example 24 | 50.00 | Polypox ® H 488 | 25.54 |
| Example 25 | 49.99 | Polypox ® H 488 | 23.60 |
| Example 26 | 50.00 | Polypox ® H 488 | 22.36 |
| Example 27 | 50.00 | Polypox ® H 488 | 26.42 |
| Example 28 | 49.99 | Polypox ® H 488 | 24.74 |
| Example 29 | 49.99 | Polypox ® H 488 | 23.60 |

### Examples 30-41 Curable Compositions Including a Hardner at a 1:0.8 Epoxy to Hardner Equivalent Ratio and Cured Coatings Formed Therefrom

Prepare curable compositions including a hardener, Examples 30-35, as follows. Add a hardener to the epoxy resin compositions of Examples 1-2, 4-5, and 7-8. For instance, a curable composition, Example 30, corresponds to the addition of hardener to the epoxy resin composition of Example 1. Similarly, curable compositions, Examples 36-41, were formed by addition of a hardener to the epoxy resin composition of Examples 1-2, 4-5 and 7-8. Two different hardeners, (Polypox® H 015 or Polypox® H 488) were utilized in various amounts in Examples 30-35 and 36-41, respectively, as reported in Table 5.

Form cured coatings as follows. Apply curable compositions, such as those in Examples 30-41, to a substrate, for example, metal panels, according to ASTM D4147-99(2007) using a 6 mm drawdown bar. All thickness ranged from 2 mil to 4 mil, as shown in Table 9. Properties of the curable compositions, 30-41, were tested along with resultant properties of cured coatings, to yield the results reported in Table 9.

TABLE 5

| | Epoxy resin | | Hardener |
|---|---|---|---|
| Curable | composition | | added |
| compositions | added (g) | Hardener | (g) |
| Example 30 | 40.00 | Polypox ® H 015 | 13.88 |
| Example 31 | 40.00 | Polypox ® H 015 | 12.06 |
| Example 32 | 40.00 | Polypox ® H 015 | 13.19 |
| Example 33 | 40.00 | Polypox ® H 015 | 12.18 |
| Example 34 | 40.00 | Polypox ® H 015 | 13.64 |
| Example 35 | 40.00 | Polypox ® H 015 | 12.77 |
| Example 36 | 40.00 | Polypox ® H 488 | 16.35 |
| Example 37 | 40.00 | Polypox ® H 488 | 14.96 |
| Example 38 | 40.00 | Polypox ® H 488 | 16.35 |
| Example 39 | 40.00 | Polypox ® H 488 | 15.11 |
| Example 40 | 40.00 | Polypox ® H 488 | 16.91 |
| Example 41 | 40.00 | Polypox ® H 488 | 15.83 |

### Comparative Examples F-K Curable Compositions Including a Hardner at a 1:1 Epoxy to Hardner Equivalent Ratio and Cured Coatings Formed Therefrom

Prepare curable compositions including a hardener, Comparative Examples F-K, as follows. Add a hardener to the commercially available epoxy resin compositions, Comparative Examples, C, D, and E, as reported in Table 6. Two different hardeners, (amine, Polypox® H 015 or Polypox® H 488) were utilized in various amounts in Comparative Examples F-K as reported in Table 6. Add additional amounts of xylene, as reported in Table 7, to reach a total of 37% solvent in the epoxy resin compositions including D.E.R.™ 671X75.

Cured coatings were formed as follows. Apply curable compositions, such as those in Comparative Examples E-K, to a substrate, for example, metal panels, according to ASTM D4147-99(2007) using a 6 mm drawdown bar. Note, for the D.E.R.™ 671X75 formulation, a 10 mils bar was used. All thickness ranged from 2 mil to 4 mil, as shown in Table 10. Properties (e.g., viscosity) of the epoxy resin compositions including the commercially available epoxy resin including at least one solvent or diluent were tested along with resultant properties of cured coatings to yield the results reported in Table 10.

TABLE 6

| Epoxy resin | | Epoxy | | | |
|---|---|---|---|---|---|
| compositions | Epoxy | resin com- | | Hardener | Xylene |
| including a | resin com- | position | | added | added |
| hardner | position | added (g) | Hardener | (g) | (g) |
| Comparative | D.E.R. ™ | 50.00 | Polypox ® | 5.85 | 9.85 |
| Example F | 671X75 | | H 015 | | |
| Comparative | D.E.R. ™ | 50.00 | Polypox ® | 20.59 | 0 |
| Example G | 321 | | H 015 | | |
| Comparative | D.E.R. ™ | 50.00 | Polypox ® | 14.33 | 0 |
| Example H | 3680X90 | | H 015 | | |
| Comparative | D.E.R. ™ | 50.00 | Polypox ® | 7.27 | 10.11 |
| Example I | 671X75 | | H 488 | | |
| Comparative | D.E.R. ™ | 50.00 | Polypox ® | 25.53 | 0 |
| Example J | 321 | | H 488 | | |
| Comparative | D.E.R. ™ | 50.00 | Polypox ® | 17.78 | 0 |
| Example K | 3680X90 | | H 488 | | |

### Comparative Examples L-Q Curable Compositions Including a hardner at a 1:0.8 Epoxy to Hardner Equivalent Ratio and Cured Coatings Formed Therefrom

Prepare curable compositions including a hardener, Comparative Examples L-Q, as follows. Add a hardener to the commercially available epoxy resin compositions, Comparative Examples, C, D, and E, as reported in Table 7. Two different hardeners, (Polypox® H 015 or Polypox® H 488) were utilized in various amounts in Comparative Examples L-Q as reported in Table 7. Add additional amounts of xylene, as reported in Table 7, to reach a total of 37% solvent in the epoxy resin compositions including D.E.R.™ 671X75.

Cured coatings were formed were formed as follows. Apply curable compositions, such as those in Comparative Examples L-Q, to a substrate, for example, metal panels, according to ASTM D4147-99 using 6 mm drawdown bar is placed behind the coating. Note, for the D.E.R.™ 671X75 formulation, a 10 mils bar was used. All thickness ranged from 2 mil to 4 mil, as shown in Table 11. Properties of the epoxy resin compositions including the commercially available epoxy resin including at least one solvent and the hardner were tested along with resultant properties of cured coatings to yield the results reported in Table 11.

TABLE 7

| | | Epoxy | | | |
|---|---|---|---|---|---|
| | Epoxy | resin com- | | Hardener | Xylene |
| Curable | resin com- | position | | added | added |
| compositions | position | added (g) | Hardener | (g) | (g) |
| Comparative | D.E.R. ™ | 35.00 | Polypox ® | 3.28 | 6.76 |
| Example L | 671X75 | | H 015 | | |
| Comparative | D.E.R. ™ | 35.00 | Polypox ® | 11.53 | 0 |
| Example M | 321 | | H 015 | | |
| Comparative | D.E.R. ™ | 35.00 | Polypox ® | 8.03 | 0 |
| Example N | 3680X90 | | H 015 | | |
| Comparative | D.E.R. ™ | 35.00 | Polypox ® | 4.07 | 6.90 |
| Example O | 671X75 | | H 488 | | |
| Comparative | D.E.R. ™ | 35.00 | Polypox ® | 14.29 | 0 |
| Example P | 321 | | H 488 | | |
| Comparative | D.E.R. ™ | 35.00 | Polypox ® | 9.95 | 0 |
| Example Q | 3680X90 | | H 488 | | |

TABLE 8
Curable compositions and properties of cured coatings

| | | | | | | | | | MEK | | | | | |
|---|---|---|---|---|---|---|---|---|---|---|---|---|---|---|
| | Viscosity | | | | | Coating | | | double | 3% | | | | |
| | (cP at | Thickness | Force | | Bend | Tg | Direct | Indirect | rub | Acetic | 10% | 3% | | |
| | 25° C.) | (Mil) | cured | Adhesion | Flexibility | (° C.) | Impact | Impact | (times) | Acid | NaOH | NaCL | Toluene | EtOH |
| Example | 1110 | 3.32 | 127 | 5 | P | 44 | 160 | 160 | 200+ | 3 | 4 | 5 | 4 | 5 |
| 12 | | | | | | | | | | | | | | |
| Example | 2017 | 3.72 | 132 | 5 | P | 40 | 160 | 160 | 180 | 3 | 5 | 5 | 4 | 5 |
| 13 | | | | | | | | | | | | | | |
| Example | 3751 | 3.21 | 130 | 5 | P | 42 | 160 | 160 | 125 | 4 | 5 | 5 | 5 | 5 |
| 14 | | | | | | | | | | | | | | |
| Example | 924 | 2.97 | 98 | 5 | P | 48 | 160 | 160 | 200+ | 4 | 5 | 5 | 5 | 5 |
| 15 | | | | | | | | | | | | | | |
| Example | 1673 | 3.26 | 102 | 5 | P | 38 | 160 | 160 | 200+ | 4 | 5 | 4 | 5 | 5 |
| 16 | | | | | | | | | | | | | | |
| Example | 2438 | 3.16 | 110 | 5 | P | 37 | 160 | 160 | 200+ | 3 | 5 | 5 | 5 | 5 |
| 17 | | | | | | | | | | | | | | |
| Example | 771 | 3.07 | 94 | 5 | P | 47 | 160 | 160 | 200+ | 3 | 5 | 5 | 4 | 5 |
| 18 | | | | | | | | | | | | | | |
| Example | 1267 | 3.14 | 86 | 5 | P | 41 | 160 | 160 | 200+ | 5 | 5 | 5 | 5 | 5 |
| 19 | | | | | | | | | | | | | | |
| Example | 1997 | 3.31 | 87 | 5 | P | 46 | 160 | 160 | 200+ | 5 | 5 | 5 | 5 | 5 |
| 20 | | | | | | | | | | | | | | |
| Example | 709 | 3.32 | 129 | 5 | P | 70 | 160 | 160 | 200+ | 3 | 5 | 5 | 5 | 5 |
| 21 | | | | | | | | | | | | | | |
| Example | 1221 | 3.72 | 136 | 5 | P | 73 | 160 | 160 | 200+ | 5 | 5 | 5 | 5 | 5 |
| 22 | | | | | | | | | | | | | | |
| Example | 2022 | 3.15 | 115 | 5 | P | 56 | 160 | 160 | 200+ | 3 | 5 | 5 | 5 | 5 |
| 23 | | | | | | | | | | | | | | |
| Example | 627 | 2.97 | 119 | 5 | P | 68 | 160 | 160 | 200+ | 3 | 5 | 5 | 5 | 5 |
| 24 | | | | | | | | | | | | | | |
| Example | 1087 | 3.26 | 102 | 5 | P | 67 | 160 | 160 | 200+ | 3 | 5 | 5 | 5 | 5 |
| 25 | | | | | | | | | | | | | | |
| Example | 1604 | 3.19 | 117 | 5 | P | 60 | 160 | 160 | 200+ | 2 | 5 | 5 | 5 | 5 |
| 26 | | | | | | | | | | | | | | |
| Example | 525 | 3.07 | 143 | 5 | P | 69 | 160 | 160 | 200+ | 3 | 5 | 5 | 5 | 5 |
| 27 | | | | | | | | | | | | | | |
| Example | 814 | 3.14 | 141 | 5 | P | 65 | 160 | 160 | 200+ | 3 | 5 | 5 | 5 | 5 |
| 28 | | | | | | | | | | | | | | |
| Example | 1248 | 3.05 | 121 | 5 | P | 57 | 160 | 160 | 200+ | 3 | 5 | 5 | 5 | 5 |
| 29 | | | | | | | | | | | | | | |

TABLE 9

| Curable | | | | | | | | | | | | | | |
|---|---|---|---|---|---|---|---|---|---|---|---|---|---|---|
| compositions | | | | | | | | | | | | | | |
| and | | | | | | | | | MEK | | | | | |
| properties | Viscosity | | | | | Coating | | | double | 3% | | | | |
| of cured | (cP at | Thickness | Force | | Bend | Tg | Direct | Indirect | rub | Acetic | 10% | 3% | | |
| coatings | 25° C.) | (Mil) | cured | Adhesion | Flexibility | (° C.) | Impact | Impact | (times) | Acid | NaOH | NaCL | Toluene | EtOH |
| Example | 1171 | 3.32 | 154 | 5 | P | 35 | 160 | 160 | 186 | 5 | 5 | 5 | 5 | 5 |
| 30 | | | | | | | | | | | | | | |
| Example | 2419 | 3.72 | 151 | 5 | P | 34 | 160 | 160 | 135 | 2 | 5 | 5 | 5 | 5 |
| 31 | | | | | | | | | | | | | | |
| Example | 791 | 2.97 | 129 | 5 | P | 33 | 160 | 160 | 155 | 5 | 5 | 5 | 5 | 5 |
| 32 | | | | | | | | | | | | | | |
| Example | 1291 | 3.26 | 127 | 5 | P | 33 | 160 | 160 | 200 | 3 | 5 | 5 | 5 | 5 |
| 33 | | | | | | | | | | | | | | |
| Example | 612 | 3.07 | 127 | 5 | P | 31 | 160 | 160 | 182 | 3 | 5 | 4 | 5 | 5 |
| 34 | | | | | | | | | | | | | | |
| Example | 934 | 3.14 | 93 | 5 | P | 31 | 160 | 160 | 183 | 3 | 5 | 5 | 5 | 5 |
| 35 | | | | | | | | | | | | | | |
| Example | 622 | 3.32 | 44 | 5 | P | 45 | 160 | 160 | 200 | 4 | 5 | 5 | 5 | 5 |
| 36 | | | | | | | | | | | | | | |
| Example | 1171 | 3.72 | 52 | 5 | P | 44 | 160 | 160 | 200 | 2 | 5 | 5 | 5 | 4 |
| 37 | | | | | | | | | | | | | | |
| Example | 540 | 2.97 | 33 | 5 | P | 44 | 160 | 160 | 174 | 2 | 5 | 5 | 5 | 5 |
| 38 | | | | | | | | | | | | | | |
| Example | 878 | 3.26 | 51 | 5 | P | 39 | 160 | 160 | 200 | 3 | 5 | 5 | 5 | 5 |
| 39 | | | | | | | | | | | | | | |
| Example | 448 | 3.07 | 69 | 5 | P | 39 | 160 | 160 | 200 | 2 | 5 | 5 | 5 | 5 |
| 40 | | | | | | | | | | | | | | |
| Example | 691 | 3.14 | 38 | 5 | P | 40 | 160 | 160 | 150 | 2 | 5 | 5 | 5 | 3 |
| 41 | | | | | | | | | | | | | | |

TABLE 10

| Curable | | | | | | | | | | | | | | |
|---|---|---|---|---|---|---|---|---|---|---|---|---|---|---|
| compositions | | | | | | | | | | | | | | |
| and | | | | | | | | | Mek | | | | | |
| properties | Viscosity | Thick- | | | | Coating | | | double | 3% | | | | |
| of cured | (cP at | ness | Forced | | Bend | Tg | Direct | Indirect | rub | Acetic | 10% | 3% | | |
| coatings | 25° C.) | (mil) | cured | Adhesion | Flexibility | (° C.) | Impact | Impact | (times) | Acid | NaOH | NaCL | Tolune | EtOH |
| Comparative | 1278 | 3.68 | 152 | 5 | P | 109 | 160 | 160 | 200+ | 5 | 5 | 5 | 5 | 5 |
| Example K | | | | | | | | | | | | | | |
| Comparative | 908 | 3.24 | 190 | 4 | F | 54 | 40 | 10 | 200+ | 4 | 5 | 5 | 5 | 5 |
| Example J | | | | | | | | | | | | | | |
| Comparative | 3220 | 2.96 | 171 | 4 | P | 71 | 160 | 160 | 200+ | 4 | 5 | 5 | 5 | 5 |
| Example I | | | | | | | | | | | | | | |
| Comparative | 1319 | 3.62 | 161 | 5 | P | 120 | 160 | 160 | 200+ | 5 | 5 | 5 | 5 | 5 |
| Example H | | | | | | | | | | | | | | |
| Comparative | 540 | 2.46 | 166 | 4 | P | 81 | 160 | 100 | 200+ | 5 | 5 | 4 | 5 | 5 |
| Example G | | | | | | | | | | | | | | |
| Comparative | 2080 | 2.61 | 166 | 5 | P | 107 | 160 | 160 | 200+ | 5 | 5 | 5 | 5 | 5 |
| Example F | | | | | | | | | | | | | | |

TABLE 11

| Curable | | | | | | | | | | | | | | |
|---|---|---|---|---|---|---|---|---|---|---|---|---|---|---|
| composition | | | | | | | | | | | | | | |
| and | | | | | | | | | MEK | | | | | |
| properties | Viscosity | | | | | Coating | | | double | 3% | | | | |
| of cured | (cP at | Thickness | Force | | Bend | Tg | Direct | Indirect | rub | Acetic | 10% | 3% | | |
| coatings | 25° C.) | (mil) | cured | Adhesion | Flexibility | (° C.) | Impact | Impact | (times) | Acid | NaOH | NaCL | Tolune | EtOH |
| Comparative | 1200 | 3.68 | 153 | 4.5 | P | 91 | 160 | 160 | 160 | 5 | 5 | 5 | 5 | 5 |
| Example L | | | | | | | | | | | | | | |
| Comparative | 573 | 3.24 | 203 | 4 | F | 50 | 40 | 10 | 98 | 4 | 5 | 5 | 5 | 5 |
| Example M | | | | | | | | | | | | | | |
| Comparative | 2824 | 2.96 | 181 | 5 | P | 63 | 50 | 10 | 195 | 4 | 5 | 5 | 5 | 5 |
| Example N | | | | | | | | | | | | | | |
| Comparative | 1192 | 3.62 | 168 | 5 | P | 100 | 160 | 160 | 200 | 5 | 5 | 5 | 5 | 5 |
| Example O | | | | | | | | | | | | | | |
| Comparative | 428 | 2.46 | 108 | 5 | P | 73 | 50 | 10 | 200 | 5 | 5 | 5 | 5 | 5 |
| Example P | | | | | | | | | | | | | | |
| Comparative | 1711 | 2.61 | 121 | 5 | P | 83 | 140 | 30 | 183 | 5 | 5 | 5 | 5 | 5 |
| Example Q | | | | | | | | | | | | | | |

The data in Table 8 and Table 9 show that curable compositions formed without the addition of a solvents or diluents, Examples 12-13 and 15-41, each have a desirable viscosity while still maintaining desirable performance qualities of cured coatings formed therefrom. The desired viscosity is evidenced by a viscosity of less than 3000 cP at 25° C. for the curable compositions of Examples 12-13 and 15-41 as reported in Tables 8 and 9. The desired performance qualities are evidenced by a desired impact resistance exhibited by the cured coating formed from the curable compositions of Examples 12-13 and 15-41 each having direct and indirect impact resistance equal to 160 and/or Examples 12-13 and 15-41 each having a Tg of below 80° C., among other desired performance qualities highlighted by the data in Tables 8 and 9. In contrast to Examples 12-13 and 15-41, Comparative Examples F-Q include curable compositions having at least one solvent or diluent and/or have undesirable performance characteristics (e.g., having direct and/or indirect impact resistance equal of substantially less than 160 and/or a Tg of above 80° C.) as shown by the data in Tables 10 and 11.

1. An epoxy resin composition of Formula (I): 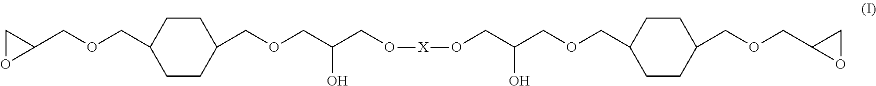
wherein X is an arylene structure derived from a compound selected from the group consisting of a monocyclic aromatic hydrocarbon, a polycyclic aromatic hydrocarbon, or a combination thereof, wherein an epoxy equivalent weight (EEW) of the epoxy resin composition is in a range from 150 to 500, and wherein m is in a mean average number in a range from 0.1 to 3.

2. The epoxy resin composition of claim 1, wherein the epoxy resin composition comprises a reaction product of (a) at least one cycloaliphatic diglycidyl ether compound, and (b) at least one aromatic diol, wherein an EEW of the cycloaliphatic diglycidyl ether compound is in a range of from 128 to 150.

3. The epoxy resin composition of claim 2, wherein the EEW of the cycloaliphatic diglycidyl ether compound is in a range of from 135 to 145.

4. The epoxy resin composition of claim 2, wherein the at least one aromatic diol is a bisphenol compound selected from the group consisting of Bisphenol-A, Bisphenol-F, or a combination thereof.

5. The epoxy resin composition of claim 2 wherein the at least one aromatic diol is selected from the group consisting of catechol, a substituted catechol, resorcinol, a substituted resorcinol, hydroquinone, a substituted hydroquinone, or a combination thereof.

6. The epoxy resin composition of claim 2, wherein the least one cycloaliphatic diglycidyl ether compound is a diglycidyl ether of cyclohexanedimethanol.

7. The epoxy resin composition of claim 2, wherein a molar ratio of the cycloaliphatic diglycidyl ether compound to the at least one aromatic diol is in a range of from 1.5 to 1.0 to 10.0 to 1.0.

8. A curable composition, comprising: an epoxy resin composition of claim 1; and a hardener, wherein the hardener reacts with the epoxy resin composition to form a cured composition.

9. The curable composition of claim 8, wherein the curable composition does include another epoxy resin composition other than the epoxy resin composition of claim 1.

10. The curable composition of claim 8, wherein the curable composition is solvent-less.

11. The curable composition of claim 8, wherein the hardener is an amine hardener.

12. A coated article comprising:
a substrate; and
a cured coating on the substrate, wherein the cured coating is formed by curing a curable composition of claim 8.

13. The coated article of claim 12, wherein the substrate is selected from a group consisting of concrete, metal, or a combination thereof.
